(19) United States
(12) Patent Application Publication
(10) Pub. No.: US 2012/0204125 A1
(43) Pub. Date: Aug. 9, 2012

(54) USER INTERFACE INCORPORATING SLIDING PANELS FOR LISTING RECORDS AND PRESENTING RECORD CONTENT

(76) Inventors: Megan Shia, San Francisco, CA (US); Le Chen, Mountain View, CA (US); Eric Hsieh, Sunnyvale, CA (US); Matthew McNulty, San Francisco, CA (US); Esther Leong, San Francisco, CA (US); Samuel Hoang, Seattle, WA (US)

(21) Appl. No.: 13/171,933

(22) Filed: Jun. 29, 2011

Related U.S. Application Data
(60) Provisional application No. 61/440,372, filed on Feb. 7, 2011.

(51) Int. Cl. G06F 3/048

(52) U.S. Cl. 715/773; 715/784; 715/781

(57) ABSTRACT

Embodiments disclosed herein describe a system and method for displaying content on a computing device. According to an embodiment, the content may be displayed on a touch sensitive display having a plurality of slidable panels. A first panel displays a list of record entries and a second panel that displays a record corresponding to a selected entry from the list of record entries in the first panel. In certain embodiments, the list of record entries in the first panel is scrollable. Furthermore, the second panel may be expandable or slidable to replace or occlude at least a portion of the first panel

### RELATED APPLICATIONS

This application claims the benefit of priority under 35 U.S.C. 119(e) to Provisional Application Ser. No. 61/440,372, filed Feb. 7, 2011, titled USER INTERFACE INCORPORATING SLIDING PANELS FOR LISTING RECORDS AND PRESENTING RECORD CONTENT, which is incorporated herein by reference in its entirety.

### TECHNICAL FIELD

The disclosed embodiments relate to the field of graphic user interfaces for mobile computing devices. More particularly, the disclosed embodiments relate to a graphic user interface that incorporates sliding panels for listing record entries and presenting record content.

### BRIEF DESCRIPTION OF THE DRAWINGS

FIGS. 1A-1C illustrate a computing device having a display configured to provide content to a user in one or more sliding panels according to one or more embodiments;

FIGS. 2A-2C illustrate a computing device having a display configured to provide content to a user in one or more sliding panels according to one or more additional embodiments;

FIG. 3 is a flow chart illustrating a method for displaying content on one or more sliding panels according to one or more embodiments;

FIG. 4 is a flow chart illustrating a method for displaying content on one or more sliding panels according to one or more embodiments;

FIGS. 5A-5B illustrate an exemplary application for providing content in one or more sliding panels according to one or more embodiments; and

FIG. 6 illustrates a hardware diagram for a portable computing device that is configured to support any of the embodiments described herein.

### DETAILED DESCRIPTION

Embodiments disclosed herein relate to a graphic user interface that incorporates sliding panels for listing record entries and presenting content from records listed thereof. According to some embodiments, such an interface may include a first panel that displays a list of record entries, and a second panel that displays record content from a selected record entry in the list of record entries in the first panel. In certain embodiments, the list of record entries in the first panel is scrollable. Furthermore, the second panel may be expandable to replace or occlude at least a portion of the first panel. Among other benefits, the interface enables the user to maximize screen area to scroll record entries (e.g. e-mails) and to view their respective contents.

Additionally, in interface such as described may include a first panel (containing list of record entries) that is moveable into a region of the touch sensitive display that was previously occupied by the second panel (displays contents of selected records from the list of record entries displayed in the first panel). Movement of the first panel in the manner described enables a third panel to be displayed on the touch sensitive display concurrently with the first panel and the second panel. The third panel may be configured to display one or more features that enable selection of one or more lists of record entries. For example, the third panel may list folders from which the list of record entries of the first panel is provided.

Numerous embodiments described herein facilitate scrolling and viewing of records. In the context of devices that use touch or context-sensitive screens (e.g. mobile computing devices or tablets), in interface such as described facilitates user input, particularly as to how output is managed on a display screen. For example, touch input can often be course. By dedicating scrolling operations to one panel, course directional input can facilitate scrolling. Record viewing can be provided in another region, and the user can have the option to expand the record reading region. Additionally, the user can have the option to introduce a third panel to view folders or other information.

In yet another embodiment, a computing device is disclosed having a memory that stores instructions for outputting a plurality of panels on a display. According to one or more embodiments, each of the plurality of panels includes at least one of an interface feature or a content. The computing device also includes one or more processors configured to detect input provided by a user. In response to the user input, at least one of the plurality of panels replaces or occludes at least a second one of the plurality of panels. In certain embodiments, the user input may correspond to directional input or contact by the user on a touch sensitive display. In another embodiment, the user input may correspond to a user selecting the content provided on at least one of the plurality of panels.

As used herein, the term “slide” means to visually simulate a first object moving over and occupying a same area as a second object. Thus, to slide over means that a first object is moved on top of a second object so as to occlude the second object. Likewise, to slide off means that the first object is moved from the top of the second object such that the second object is once again visible.

The term “panel” means a portion of a display, such as, for example a display surface or other interactive medium in which content is output. As described herein, a plurality of panels may be concurrently rendered on the display. For example, a first panel may be rendered on the display concurrently with a second panel. As further described herein, a first panel may be expandable and/or slidable such that the first panel slides over, or slides off of, a second panel. Additionally, a user may interact with the first panel such that i) the user interaction does not affect content displayed on the second panel; and ii) the user interaction does affect content displayed on the second panel.

As used herein, the terms “programmatic”, “programmatically” or variations thereof mean through execution of code, programming or other logic. A programmatic action may be performed with software, firmware or hardware, and generally without user-intervention, albeit not necessarily automatically, as the action may be manually triggered.

One or more embodiments described herein may be implemented using programmatic elements, often referred to as modules or components, although other names may be used. Such programmatic elements may include a program, a subroutine, a portion of a program, or a software component or a hardware component capable of performing one or more stated tasks or functions. As used herein, a module or component, can exist on a hardware component independently of other modules/components or a module/component can be a shared element or process of other modules/components, programs or machines. A module or component may reside on one machine, such as on a client or on a server, or may alternatively be distributed amongst multiple machines, such as on multiple clients or server machines. Any system described may be implemented in whole or in part on a server, or as part of a network service. Alternatively, a system such as described herein may be implemented on a local computer or terminal, in whole or in part. In either case, implementation of system provided for in this application may require use of memory, processors and network resources (including data ports, and signal lines (optical, electrical etc.), unless stated otherwise.

Furthermore, one or more embodiments described herein may be implemented through the use of instructions that are executable by one or more processors. These instructions may be carried on a computer-readable medium. Machines shown in figures below provide examples of processing resources and computer-readable mediums on which instructions for implementing one or more embodiments can be carried and/or executed. In particular, the numerous machines shown with one or more embodiments include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. portable devices such as cell phones) are all examples of machines and devices that utilize processors, memory, and instructions stored on computer-readable mediums.

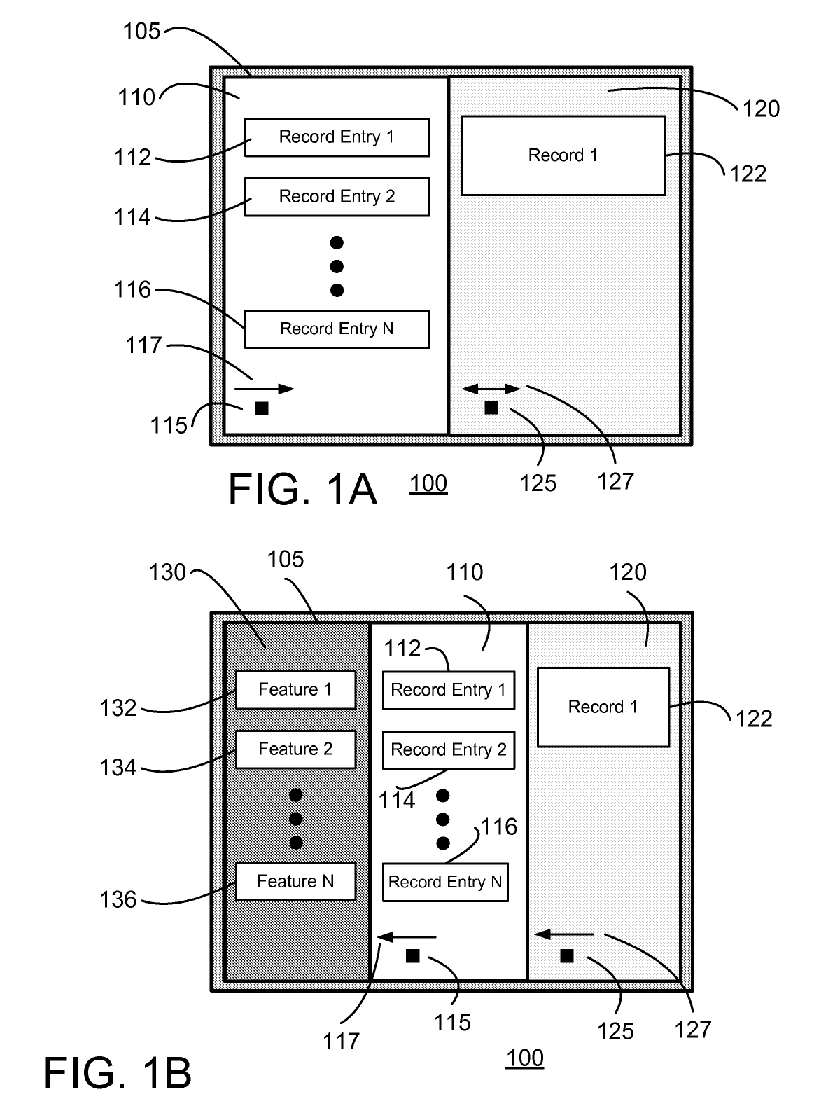

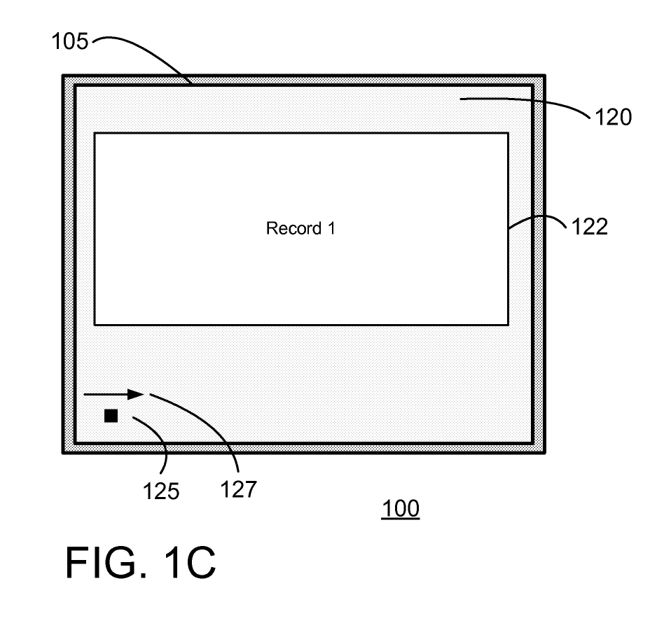

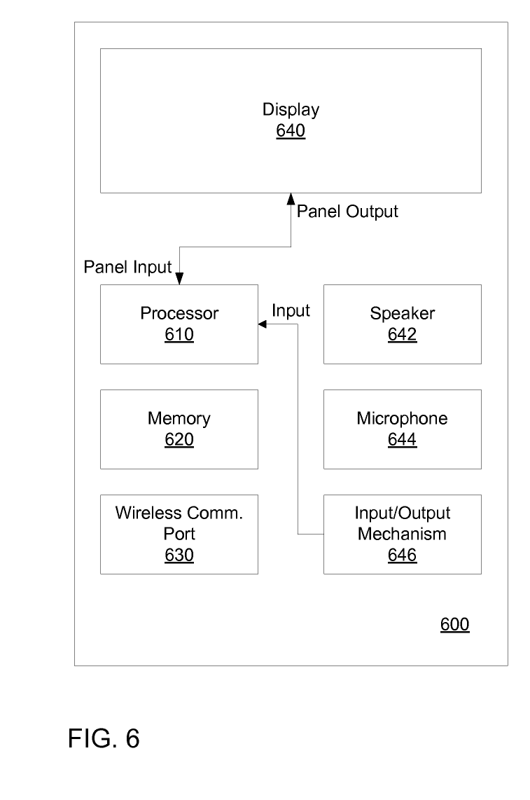

FIGS. 1A-1C illustrate a computing device 100 having a display 105 configured to provide content to a user in one or more sliding panels according to one or more embodiments. The computing device 100 may include hardware assembly such as shown by an embodiment of FIG. 6. With reference to FIG. 1, a surface of the display 105 of the computing device 100 may be responsive to touch by a finger or object. A processor of the computing device 100 is configured to present the one or more panels, and the content contained in the one or more panels, to a user based on input received from the user.

The display 105 of the computing device 100 may include a plurality of panels with each of the plurality of panels displaying content. In certain embodiments, content displayed in a first panel may correspond to content displayed in a second panel. Additionally, each of the plurality of panels may be arranged in a hierarchy. Thus, in order to view a Panel C, and the content displayed thereon, a user may be required to navigate through Panel A and Panel B.

Referring to FIG. 1A, the display 105 of the computing device 100 is shown as having a first panel 110 and a second panel 120. Although each of the first panel 110 and the second panel 120 are shown as having equivalent sizes, it is contemplated that the second panel 120 may occupy more area of the display 105 than the first panel 110. Alternatively, the first panel 110 may occupy more area of the display 105 than the second panel 120. It is also contemplated that the area of the display 105 occupied by each of the first panel 110 and the second panel 120 is selectable by the user based on user preference. In another embodiment, the area occupied by each of the first panel 110 and the second panel 120 may be application specific.

For example, if a first application is executed on the device 100, the first panel 110 may occupy a first area of the display 105 while the second panel 120 may occupy a second area of the display 105, where the first area is less than the second area. Conversely, when a second application is being executed on the device 100, the first panel 110 and the second panel 120 may occupy equivalent or substantially equivalent areas of the display 105.

In certain embodiments, the first panel 110 and the second panel 120 may be configured so as to be slidable with respect to each other. As will be explained below, each of the panels are slidable and/or expandable based on input by a user. For example, the second panel 120 may slide over the first panel 110 and be expanded such that the second panel 120 occupies the entire area of the display 105 such as shown by FIG. 1C. Additionally, each of the first panel 110 and the second panel 120 may also be slidable and/or contractible such that a third panel, such as, for example, third panel 130 (FIG. 1B) may be concurrently displayed with the first panel 110 and the second panel 120.

Referring back to FIG. 1A, in certain embodiments, the first panel 110 may contain a list of record entries. For example, the list of record entries may include Record Entry 1 112, Record Entry 2 114, and Record Entry N 116. Each record entry in the list identifies a corresponding record having content. For example, Record Entry 1 112 may identify Record 1 122. Additionally, Record Entry 2 114 may identify Record 2 (not shown) and Record Entry N 116 may identify Record N (not shown).

In certain embodiments, content displayed in each of the panels is scrollable. For example, if a particular list being displayed in first panel 110 contains more record entries than can be displayed at a single time on the space provided by the first panel 110, a user may provide directional input on the display 105 to cause the list or record entries to vertically scroll. Based on the directional input provided, the list may scroll in a first direction (e.g., vertically up) or in a second direction (e.g., vertically down). In certain embodiments, the directional input is provided by the user in the particular panel the user wishes to scroll. Thus, if the user wishes to scroll content in the first panel 110, the directional input is provided in the first panel 110. Likewise, if the user wishes to scroll content provided in the second panel 120, the directional input is provided in the second panel 120.

As discussed, a record entry may identify a particular record. In certain embodiments, a record identified by the particular record entry may be displayed in a separate panel. For example, if a user selects Record Entry 1 112 in the first panel 110, Record 1 122, or more specifically, the content of Record 1 122, is displayed in the second panel 120. Likewise, if a user selects Record Entry 2 114 or Record Entry N 116, the records corresponding to each of the record entries will be displayed in the second panel 120. Although the content displayed in the second panel 120 may be dependent on the content displayed in the first panel 110, the content displayed in the second panel 120 may be scrollable independent from the content displayed in the first panel 110 as discussed above.

The first panel 110 may also include an icon or handle 115 to enable a user to provide directional input 117 on the display 105 of the computing device 100. For example, if the user wishes to display a third panel concurrently with the first panel 110 and the second panel 120, such as, for example, third panel 130 (FIG. 1B), the user may actuate the handle 115 and provide directional input 117 in a first direction. In response to the directional input, the first panel 110 and/or the second panel 120 contract and the first panel 110 slides off of the third panel 130. In certain embodiments, the directional input 117 may correspond to a dragging motion in which the handle 115 of the first panel 110 is actuated by a user and is dragged in the first direction (e.g., toward the second panel). In another embodiment, the user actuation of the handle 115 may correspond to single input, such as, for example a tap or tapping motion on the handle 115. In response to the tap or the tapping motion on the handle 115, each of the first panel 110 and the second panel 120 slide and/or contract such that the third panel 130 is output on the display concurrently with the first panel 110 and the second panel 120. Accordingly, user actuation of the handle 115 using a tap or tapping motion causes each of the panels to expand and/or slide in the same manner as if the user had actuated the handle and dragged the handle in the first direction. As alternatives, various other forms of user-input may be used in order to operate the user-interface described (e.g. swipes, flicks, pinch, tap and hold).

Regarding the contracting and/or sliding motion described above, in order to make room on the display 105 for the third panel 130, the first panel 110 is moveable into a region of the display 105 that was previously occupied by the second panel 120. Additionally, a position and/or a dimension (e.g., height and/or width) of each of the first panel 110 and the second panel 120 are modified such that, visually, it appears as if the second panel 120 and the first panel 110 are “moving over” to make room on the display 105 for the third panel 130.

Referring to FIG. 1B, as shown, each of the first panel 110, the second panel 120, and the third panel 130 may be output on the display 105 concurrently. Although FIG. 1B shows that each of the first panel 110, the second panel 120 and the third panel 130 occupy substantially equivalent areas of the display 105, it is contemplated that each of the panels may occupy non-equivalent areas of the display 105. For example, the second panel 120 may occupy 50% of the display 105, the first panel 110 may occupy 30% of the display 105 and the third panel 130 may occupy the remaining 20% of the display. It is also contemplated that two panels may occupy equivalent areas of the display 105 while a third panel occupies a larger or smaller area of the display 105. For example, the first panel 110 and the second panel 120 may each occupy 40% of the display 105 while the third area occupies 20% of the display 105.

In an embodiment, as each of the panels are slide and/or are expanded/contracted based on the received user input, content displayed in each of the panels may also be sized or reformatted accordingly. For example, as shown in FIG. 1A, each of the record entries output on the first panel 110 of the display 105 are formatted so as occupy substantially the entire width of the first panel 110. Similarly, Record 1 122 in the second panel 120 is shown to occupy substantially the entire width of the second panel 122. However, when comparing each of the list entries of the first panel 110 of FIG. 1A to each of the list entries of the first panel 110 of FIG. 1B, it is shown that the overall width of each of the list entries in the first panel of FIG. 1B has been reduced. Likewise, when comparing the width of Record 1 122 of FIG. 1A to the width of Record 1 122 of FIG. 1B, it can be seen that the width of Record 1 122 of FIG. 1B has also been reduced. Because the width of each of the panels may change based on the number of panels output on the display 105, the content contained in each of the panels may be formatted accordingly.

For example, if Record 1 122 contains text, the text may be reformatted so as to utilize wrap around text. Thus the entire text content may still be viewable in the second panel 120. If the entire text content cannot be displayed in the given area of the panel, a user may be able scroll the text up and down within the area defined by the second panel 120. In another embodiment, ellipses or other indicators may be used to indicate that additional text is available. For example, each record entry displayed in the first panel 110 may include text identifiers. Due the available width of the first panel 110, the entire text for some of the text identifiers may not being fully displayed. As such, ellipses or other characters may be displayed to indicate that the full text identifier is not currently viewable. In another embodiment, the text of the text identifier may be automatically sized (e.g., output in a smaller font) so that the entire text identifier is displayed in the available area.

Referring back to FIG. 1B, the third panel 130 may include one or more features, such as, for example, Feature 1 132, Feature 2 134, and Feature N 136. Each of the features may enable selection of one or more lists of record entries. Thus, each feature has a corresponding list of record entries, with each record entry in each of the lists having corresponding records. Therefore, selection of a first feature (e.g., Feature 1 132) in the third panel 130 causes a first list to be output in the first panel 110 and selection of a second feature (e.g., Feature 2 134) in the third panel 130 causes a second list to be output in the first panel 110.

For example, selection of Feature 1 132 in the third panel 130 may cause a list of record entries having Record Entry 1 112, Record Entry 2 114, and Record Entry N 116 to be output in the first panel 110 of the display 105. However, selection of Feature 2 134 in the third panel 130 may cause a list of record entries having Record Entry 1′ (not shown), Record Entry 2′ (not shown) and Record Entry N′ (not shown) to be output in the first panel 110 of the display 105. As discussed, each record entry identifies a corresponding record having content. Therefore, to access the content of Record 1 122, a user would select Feature 1 132 in the third panel 130 of the display 105 and subsequently select Record Entry 1 112 in the first panel 110 of the display 105. Likewise, to access content contained in Record 2′ (not shown) a user may select Feature 2 134 in the third panel 130 of the display 105 and subsequently select Record Entry 2′ (not shown) in the first panel 110 of the display 105.

In certain embodiments, at least one of the panels may include a user interface feature. As the user interface feature may be provided as, or included with, one of the plurality of panels, the user interface feature may be made available only when the particular panel is in view. For example, the third panel 130 may be configured to display a virtual keyboard. Thus, when a user wishes to use the virtual keyboard, the first panel 110 and/or the second panel 120 may be configured to contract and/or slide off of the third panel 130 such that the virtual keyboard is accessible.

Referring back to the one or more features described above, in an embodiment, once one of the features (e.g., Feature 1 132, Feature 2 134, or Feature N 136) has been selected by a user, the first panel 110 and the second panel 120 slide back to the areas on the display 105 that each panel occupied prior to the third panel 130 being output on the display 105. In certain embodiments, the first panel 110 and/or the second panel 120 slide and/or expand so as to occupy the area of the display 105 that was previously occupied by the third panel 130. This expansion may occur automatically upon user selection of at least one of the features displayed in the third panel 130. In another embodiment, a user may actuate a handle 115 on the first panel 110 and provide directional input 117 (e.g., in a direction toward the third panel 130 as indicated by the directional arrow) to the display 105. In response to the directional input 117, each of the first panel 110 and the second panel 120 slide back to the areas on the display 105 as was described above. In yet another embodiment, a user may actuate the handle 115 using a tap or tapping motion. In response to the tap or tapping motion, each of the first panel 110 and the second panel 120 expand and/or slide back to the areas on the display 105 that each panel occupied prior to the third panel 130 being output on the display 105. As alternatives, various other forms of user-input may be used in order to operate the user-interface described (e.g. swipes, flicks, pinch, tap and hold).

In another embodiment, a user may actuate handle 125 provided on the second panel 120 of the display 105 and provide directional input 127 (e.g., in the direction of the first panel 110 and the third panel 130 as indicated by directional arrow) on the display 105. Alternatively, the user may actuate the handle 125 using a tap or tapping motion as described above. In response to the directional input 127 or the tapping motion, the first panel 110 and/or the second panel 120 expand and slide such that at least the first panel 110 slides over the third panel 130 so as occlude the third panel 130. Further directional input 127 or an additional tap or tapping motion on the handle 125, causes the second panel 120 to expand and/or slide over the first panel 110 such that the second panel 120 occludes the first panel 110. As a result, the second panel 120 occupies the entire area of the display 105. An example of the second panel 120 occupying the entire area of the display 105 is provided in FIG. 1C.

Referring to FIG. 1C, as shown, panel 120 occupies the entire area of the display 105. Record 1 122 has also been expanded accordingly. Thus, a user may view or otherwise access the content of Record 1 122 on the full area of the display 105. In certain embodiments, the second panel 120 may be scrollable based on directional user input (e.g., vertical upward motion or vertical downward motion on the display 105) as described above.

Once the second panel 120 has occupied the entire area of the display 105, a user may provide directional input 127 on the display 105 in a second direction (e.g., a direction away from the location at which the first panel 110 was previously located as indicated by the directional arrow). In response to the directional input 127, the second panel contracts and/or slides off of the first panel 110, thereby causing the first panel 110 to be viewable. Further directional input 127 in the same direction causes the second panel 120 and/or the first panel 110 to further contract and/or slide, such that the first panel 110 slides off of the third panel 130. As a result, each of the three panels are once again displayed.

Referring back to FIG. 1A, both the first panel 110 and the second panel 120 may include handles to enable a user to provide directional input. As discussed, if a user actuates handle 115 on the first panel 110 either by i) a first tap or tapping motion or ii) by selecting the handle 115 and providing directional input 117 in a direction toward the second panel 120 (e.g., as indicated by the directional arrow), both the first panel 110 and the second panel 120 contract and/or slide such that the first panel 110 slides off of the third panel 130. As a result, the third panel 130 is concurrently displayed with the first panel 110 and the second panel 120. It is also contemplated that the user may actuate the handle 125 on the second panel 120 using a second tap or tapping motion or by selecting the handle 125 and providing directional input 127 in a second direction (e.g., in a direction away from the first panel 110) on the display 105. In response to the received input, the first panel 110 and the second panel 120 contract and/or slide away from a location of the third panel such that the third panel 130 is output on the display 105.

Additionally, a user may actuate the handle 125 in the second panel 120 and provide directional input 127 in a second direction (e.g., in a direction toward the first panel 110) on the display 105. A user may also actuate the handle 125 using a second tap or a tap or tapping motion, different than the tap or tapping motion described above, in order to cause the second panel 120 to move in the second direction. For example, a single tap of the handle 125 may cause the second panel to move in a first direction (e.g., in a direction away from the first panel 110) while a double tap of the handle 125 may cause the panel to move in a second direction (e.g., in a direction toward the first panel 110). In response to the user input (e.g., the tap or tapping motion or the directional input 127), the second panel 120 expands and slides over the first panel 110. As a result, the second panel 120 occupies the entire area of the display 105 such as shown in FIG. 1C.

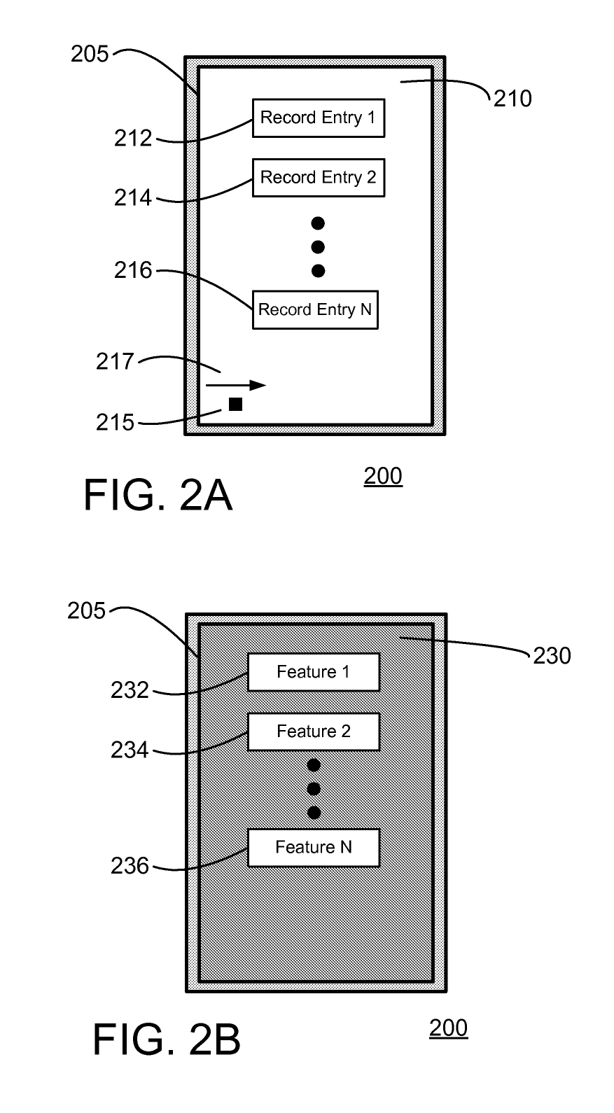

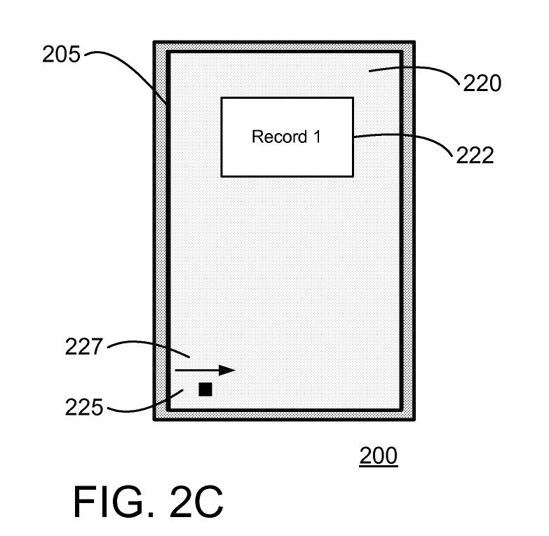

FIGS. 2A-2C illustrate a computing device 200 having a display 205 configured to provide content to a user in one or more sliding panels according to one or more additional embodiments. The computing device 200 may include hardware assembly such as shown by an embodiment of FIG. 6. As with the display 105 of FIG. 1, the display 205 of the computing device 200 may be responsive to touch by a finger or object. A processor of the computing device 200 is configured to present the one or more panels, and the content contained in the one or more panels to a user, based on input received from the user.

In certain embodiments, the computing device 200 includes a display 205 configured to display content contained in a plurality of panels to a user. In certain embodiments, each of the panels described with respect to FIGS. 2A-2C may be arranged in a hierarchy as was described above with respect to FIGS. 1A-1C. However, as shown in FIGS. 2A-2C, the display 205 of the computing device 200 may have a smaller area than the display 105 (FIG. 1A) of the computing device 100. Due to the smaller area of the display 205, it may not be ideal to concurrently output a plurality of panels on the smaller display 205. However, content in each of the plurality of panels may still be accessed in a manner similar to that described above.

Referring to FIG. 2A, a first panel 210 may be provided on a display 205 of the computing device 200. The first panel 210 may include content such as, for example, of list of record entries with each record entry identifying a record. For example, the list of record entries may include Record Entry 1 212, Record Entry 2 214 and Record Entry N 216 with Record Entry 1 212 identifying Record 1 222 (FIG. 2C), Record Entry 2 214 identifying Record 2 (not shown) and Record Entry N identifying Record N (not shown).

The first panel 210 may also include a handle 215 to enable a user to provide either i) a tap or tapping motion, or ii) directional input 217. In certain embodiments, another panel may be output on the display 205 in response to the directional input or the tap or tapping motion. For example, if a user actuates the handle 215 on the first panel and provides directional input 217 in a first direction (e.g., in the direction indicated by the directional arrow), the first panel 210 slides off of a third panel 230 such that the third panel 230 is output on the display 205.

As shown in FIG. 2B, the third panel 230 may include one or more features that enable selection of one or more lists of record entries. As described above, each feature may correspond with, or identify, a particular list of record entries. For example, Feature 1 232 may correspond with or identify the record entry list that includes Record Entry 1 212, Record Entry 2 214, and Record Entry N 216 (FIG. 2A). Likewise, Feature 2 234 and Feature N 236 may also correspond with or identify respective lists of record entries. For example Feature 2 234 may correspond with a list having Record Entry 1′ (not shown), Record Entry 2′ (not shown) and Record Entry N′ (not shown). As discussed above, Record Entry 2′ may identify a record, such as for example, Record 2′ (not shown) having content.

In certain embodiments, once a feature displayed on the third panel 230 has been selected by a user, the first panel 210 automatically slides over the third panel 230 such that the first panel is output on the display 205. As a result, only the first panel 210 is output on the display 205.

As discussed above, the first panel 210 may display a list of record entries with each record entry identifying a record having content. In certain embodiments, once a particular record entry in the list is selected, a second panel, such as, for example, second panel 220 (FIG. 2C) slides over the first panel 210 such that the second panel 220 is the only panel viewable on the display 205. Referring to FIG. 2C, once the second panel 220 is output on the display 205, the content of the record, such as, for example Record 1 222 is output on the display 205.

The second panel 220 also includes a handle 225 to enable a user to provide directional input 227 or a tap or tapping motion. As with other handles described herein, when the user actuates the handles 225 and provides either i) a tap or a tapping motion, or ii) directional input 227 in a particular direction (e.g., in the direction indicated by the directional arrow), the second panel 220 slides off of the first panel 210. As a result, the first panel 210 is once again output on the display 205 such as shown in FIG. 2A.

As with each of first panel 110, the second panel 120, and the third panel 130 of the device 100 of FIGS. 1A-1C, each of the first panel 210, the second panel 220 and the third panel 230 of the device 200 are scrollable so as to enable a user to view additional content. Additionally, each of the first panel 210, the second panel 220, and the third panel 230 are arranged in a hierarchy such that content in a particular panel in a lower level of the hierarchy will only be displayed based on selection of content in a particular panel in an upper level of the hierarchy.

### Methodology

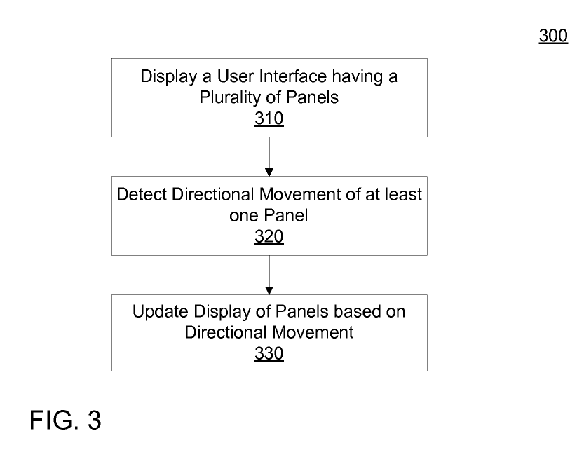

FIG. 3 is a flow chart illustrating a method 300 for displaying content on one or more sliding panels according to one or more embodiments. A method 300 may be used in conjunction with computing device 100 such as described above with respect to FIGS. 1A-1C. Therefore, the following description may refer to one or more components described with respect to FIGS. 1A-1C. However, any such reference the components of FIGS. 1A-1C are for descriptive purposes only.

A method 300 for displaying content on or more sliding panels begins when a user interface having a plurality of panels is output on a display 310, such as, for example, display 105 (FIG. 1). Each of the plurality of panels may include content. The content on a first panel of the plurality of panels may identify or correspond with content that is displayed on a second panel of the plurality of panels. Additionally, as described above, selection of content on a first panel may cause a second panel to automatically slide over the first panel.

In certain embodiments, at least one of the plurality of panels may be scrollable such that additional content may be output on the display. For example, if the content displayed in a first panel is a list of record entries and the list contains a number of entries such that each entry cannot be displayed at once, a user may provide directional input to the touch sensitive display of the device such that additional record entries of the list may be output on the display. In certain embodiments, each of the plurality of panels may be scrollable independent from each of the other panels.

Additionally, at least one of the plurality of panels may include an icon or handle so as to enable a user to provide directional input. When the directional input is detected 320, the configuration of the panels is updated based on the directional movement 330. In certain embodiments, the directional input may correspond to a user touching an area of the touch sensitive display of the computing device and performing an action or motion. For example, a user may actuate the handle or icon by touching a portion of the touch sensitive display on which the handle or icon is located and drag the handle in a first direction. Alternatively, a user may actuate the handle or icon by providing a tap or a tapping motion. In response to the user actuation of the handle or icon, at least one of the plurality of panels may either i) slide over a second one of the plurality of panels, or ii) slide off of a second one of the plurality of panels such that the second one of the plurality of panels is viewable.

For example, as discussed above with respect to FIGS. 1A-1C, if a user actuates handle 115 of the first panel 110 and provides directional input 117 in a direction toward the second panel 120, the first panel 110 slides off of the third panel 130 such that each of the first panel 110, the second panel 120 and the third panel 130 are concurrently output on the display 105.

Continuing with the above example, if a user selects handle 125 on the second panel 120 and provides directional input in a direction toward the first panel 110, the second panel 120 expands and/or slides over the first panel 110. As a result, the second panel 120 occupies the entire area of the display 105 such as shown in FIG. 1C. If the handle 125 is subsequently actuated by the user and the user provides directional input in a second direction (e.g., in the direction indicated by the directional arrow shown in FIG. 1C), the second panel 120 contracts and/or slides off of the first panel 110 such that each of the first panel 110 and the second panel are output on the display 105. In one embodiment, continued directional movement will subsequently cause the first panel 110 to slide off of the third panel 130. As a result, each of the first panel 110, the second panel 120 and the third panel 130 will be output on the display 105 such as shown in FIG. 1B.

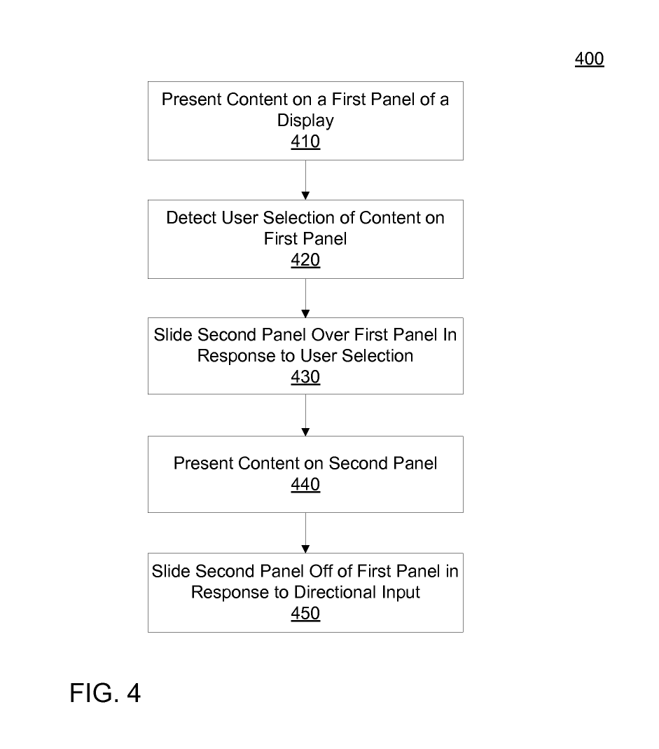

FIG. 4 illustrates a method 400 for displaying content on one or more sliding panels according to one or more additional embodiments. The method 400 described herein may be used in conjunction with computing device 200 such as described above with respect to FIGS. 2A-2C. Therefore, the following description may refer to one or more components described with respect to FIGS. 2A-2C. However, any such reference the components of FIGS. 2A-2C are for descriptive purposes only.

The method 400 for displaying content one or more sliding panels begins when content is output on a first panel of the display 410. In certain embodiments, the display may be a touch sensitive display such as, for example, display 205 (FIG. 2A). As described above, the content may correspond to a list of record entries, with each record entry in the list corresponding with or identifying a particular record having content. In another embodiment, the content may include a plurality of features with each feature corresponding to or identifying a particular list of record entries.

Once the content has been output on the first panel of the display, such as, for example, first panel 210 (FIG. 2A), user selection of at least one content item on the first panel is detected 420. In certain embodiments, the user selection may correspond to a user touching an area of the touch sensitive display that is associated with the particular content item. In response to the user selection, a second panel, such as, for example second panel 220 (FIG. 2C) slides over the first panel 210 such that the second panel 220 occludes the first panel 210 and is output on the display 430. Once the second panel 220 is displayed, content is output on the second panel 440.

In certain embodiments, the content rendered on the second panel 440 may be a record having content, such as, for example Record 1 222 (FIG. 2C). In another embodiment, the content rendered on the second panel may be a list of record entries such as, for example, a list containing Record Entry 1 212, Record Entry 2 214, and Record Entry N 216 (FIG. 2A).

In an embodiment, the second panel may contain a handle, such as, for example, handle 225 (FIG. 2C) to enable a user to provide directional input. In response to the directional input, the second panel 220 may be configured to slide off of the first panel 450 such that the first panel 210 is once again output on the display 205.

### Usage Scenario

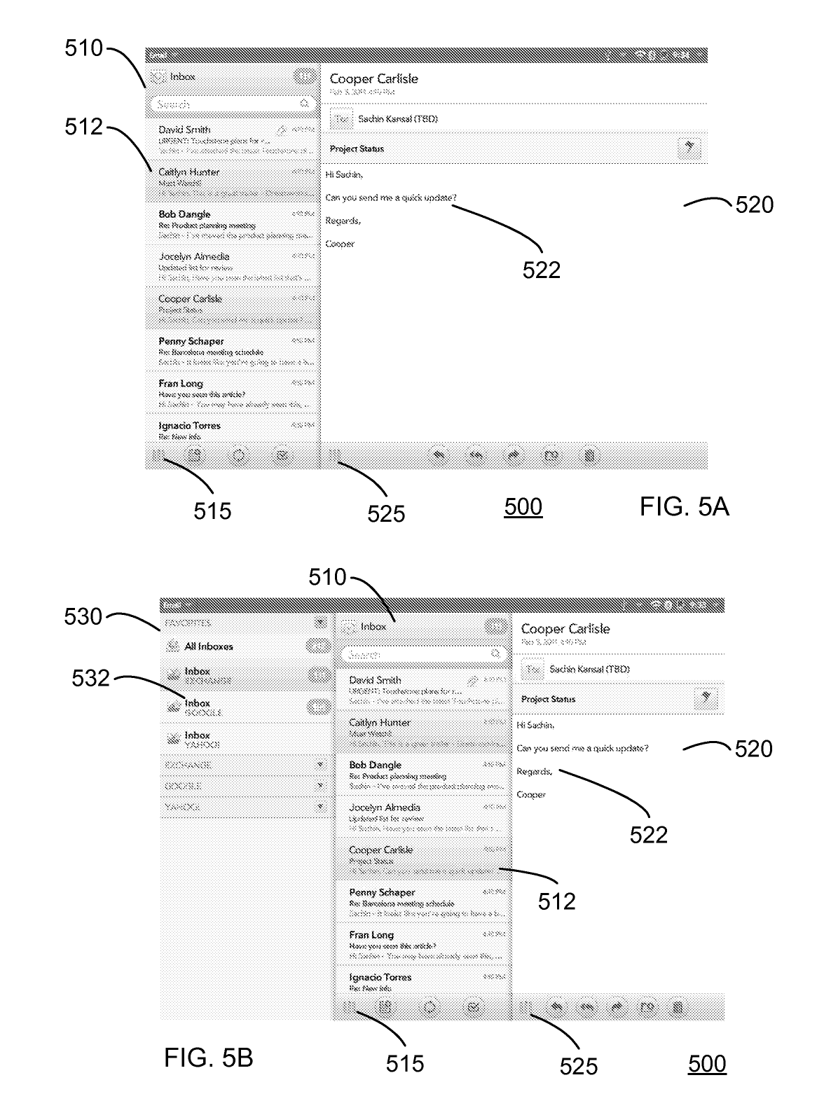

FIGS. 5A-5B illustrate an exemplary application 500 for providing content in one or more sliding panels according to one or more embodiments. The application 500, such as, for example, an email application, may be executed on a computing device 600 such as shown by an embodiment of FIG. 6. Although an email application is specifically mentioned and shown in FIGS. 5A-5B, it is contemplated that one or more embodiments disclosed herein may be utilized by any number of applications that are used to store and/or present content to a user.

Referring to FIG. 5A, it is shown that the application 500 is configured display content to a user in a first panel 510 and a second panel 520. In certain embodiments, the first panel 510 and the second panel 520 may correspond to first panel 110 and second panel 120 (FIG. 1A) respectively. As such, the first panel 510 may include a list of record entries 512 and the second panel 520 may include a record 522. For example, the first panel 510 may be configured to display an inbox of a selected email application with the inbox showing a list of all emails received by a user. In response to the user selecting one of the received emails in the first panel 510, the content of the email is concurrently displayed in the second panel 520.

In certain embodiments, each of the first panel 510 and the second panel 520 include handles 515 and 525 respectively. Handle 515 may correspond to handle 115 (FIG. 1A) and handle 525 may correspond to handle 125 (FIG. 1A). As such, if a user actuates handle 525 and provides directional input (e.g., drags the handle 525 in a direction toward the first panel 510), the second panel 520 expands and/or slides over the first panel such that the second panel 520 occupies the entire area of the display. Additionally, when a user actuates handle 515 and provides directional input (e.g., drags the handle 515 in a direction toward the second panel 520), the first panel 510 and the second panel 520 contract and/or slide such that the first panel 510 slides off of a third panel 530 (FIG. 5B) and each of the first panel 510, second panel 520 and third panel 530 are output concurrently on the display. An exemplary embodiment of each of the plurality of panels being concurrent output on a display is shown in FIG. 5B.

Referring to FIG. 5B, in certain embodiments, the third panel 530 may correspond to third panel 130 (FIG. 1B). Accordingly, the third panel 530 may include one or more features 532 with each of the features 532 identifying or corresponding to one or more lists of record entries, such as, the list of record entries 512. For example, the application 500 includes a third panel 530 in which a plurality of inboxes are shown with each inbox corresponding to a particular email application. Upon user selection of a first email application, the first panel 510 displays a list of all emails received by that particular email application. Accordingly, the second panel 520 displays the content or the body of the selected email message from the list of received emails displayed in the first panel 510.

In certain embodiments, once the particular email application in the third panel 530 has been selected by a user, the first panel 510 and the second panel 520 automatically expand and/or slide such that at least a portion of the first panel 510 slides over the third panel 530. In another embodiment, a user may actuate handle 515 or handle 525 and provide directional input (e.g. in the direction of the third panel 530) such that that the first panel 510 and/or the second panel 520 expand and/or slide over the third panel 530. As a result, the first panel 510 and the second panel 520 are output on the display.

### System Description

FIG. 6 illustrates a hardware diagram for a computing device that is configured to support any of the embodiments described herein. An embodiment of FIG. 6 is depicted as a portable computing device 600. In particular, embodiments pertain to a slate or tablet device, which is a display dominant computing device. Tablets can have a monolithic form factor. The portable computing device includes roaming wireless network and/or cellular capabilities, including cellular telephony devices and/or portable messaging.

Other embodiments described herein may apply to numerous kinds of portable or small form-factor computing devices. One type of portable computing device that may be configured to include embodiments described herein includes a computer telephony device, such as a cellular phone or portable device with voice-telephony applications (sometimes called “smart phone”). A computing device such as described may provide functionality for messaging, web browsing, media playback, personal information management (e.g. such as contact records management, calendar applications, tasks lists), image or video/media capture and other functionality.

Specific types of messaging that may be performed include messaging for email applications, Short Message Service (SMS) messages, Multimedia Message Service (MMS) messages, and proprietary voice exchange applications (such as SKYPE). Still further, other types of computing devices contemplated with embodiments described herein include laptop or notebook computers, ultra-portable computers, personal digital assistants, and other multi-functional computing devices.

Still further, one or more embodiments may be implemented through any type of computing device such as a desktop computer that is configured to include real-time voice data exchange (e.g. through use of Internet Protocol telephony). Still further, other types of computer telephony devices exist, including standalone devices that connect directly to a telephone network (whether Internet Protocol or Public Switch Telephony System (PSTN)) and provide software interfaces and applications.

According to an embodiment, the device 600 may include one or more processors 610 (as processing resources), memory resources 620, one or more wireless communication ports 630, and various other input/output features, including a display assembly 640, a speaker 642, a microphone 644 and other input/output mechanisms 646. In certain embodiments, the one or more processors 610 are configured to receive input from the input/output mechanism 646. The processor 610 may also be configured to receive panel input from one or more panels of the display 640. In certain embodiments, the panel input may correspond to a user selection of content displayed on one of the panels (e.g., user selection of a content entry or feature). In another embodiment, the panel input may correspond to directional input provided by the user. Once the panel input is received by the processor 610, the processor 610 determines which panels are to be displayed and/or the content that is to be displayed in a given panel. This information, shown as panel output, is generated and passed to the display 640. According to one or more embodiments, the display assembly 640 includes a touch-sensitive display interface to receive human contact (or close proximity) as input. More specifically, the display assembly 640 provides an interface by which a user can interact with content or features displayed on each of a plurality of panels such as described by various embodiments herein.

### CONCLUSION

It is contemplated for embodiments described herein to extend to individual elements and concepts described herein, independently of other concepts, ideas or systems, as well as for embodiments to include combinations of elements recited anywhere in this application. Although illustrative embodiments have been described in detail herein with reference to the accompanying drawings, it is to be understood that the disclosure is not limited to those precise embodiments. As such, many modifications and variations will be apparent to practitioners skilled in this art. Accordingly, it is intended that the scope of the disclosure be defined by the following claims and their equivalents. Furthermore, it is contemplated that a particular feature described either individually or as part of an embodiment can be combined with other individually described features, or parts of other embodiments, even if the other features and embodiments make no mention of the particular feature. This, the absence of describing combinations should not preclude the inventor from claiming rights to such combinations.

What is claimed is:

1. A method for displaying content on a computing device, the method comprising:
displaying an interface to view records, the interface comprising (i) a first panel that displays a list of record entries, and (ii) a second panel that displays a record corresponding to a selected entry from the list of the first panel;
enabling the list of the first panel to be scrollable, and
enabling the second panel to be expandable to replace or occlude at least a portion of the first panel.

2. The method of claim 1, further comprising enabling the first panel to be moveable into a region previously occupied by the second panel in order to display a third panel.

3. The method of claim 2, wherein enabling the first panel to be moveable into a region previously occupied by the second panel in order to display a third panel includes shifting the second panel to visually simulate the first and second panels making room for the third panel.

4. The method of claim 1, wherein the third panel displays features to enable selection of one or more lists of record entries in the first panel.

5. The method of claim 2, wherein the third panel displays one or more inboxes for images.

6. The method of claim 1, wherein enabling the list of the first panel to be scrollable includes enabling the list of the first panel to be scrollable in a vertical direction, responsive to directional contact by the user.

7. The method of claim 1, wherein enabling the second panel to be expandable includes enabling the second panel to be expandable in response to directional contact by the user.

8. The method of claim 2, wherein enabling the first panel to be moveable includes enabling the first panel to be moveable in response to directional contact by the user.

9. A computing device comprising:
a memory that stores instructions for outputting a plurality of panels on a display, wherein each of the plurality of panels includes at least one of an interface feature or a content; and
one or more processors configured to:
detect input provided by a user, wherein the input causes the at least one of the plurality of panels to replace or occlude at least a second one of the plurality of panels.

10. The computing device of claim 9, wherein the input provided by the user is directional input.

11. The computing device of claim 9, wherein the input provided by the user is user selection of the content.

12. The computing device of claim 9, wherein the interface feature is a virtual keyboard.
